(19) United States
(12) Patent Application Publication
(10) Pub. No.: US 2007/0254246 A1
(43) Pub. Date: Nov. 1, 2007

(54) Developer used for planographic printing plate material and processing method by use thereof

(75) Inventor: Kazuhiro Oikawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/790,041

(22) Filed: Apr. 23, 2007

(30) Foreign Application Priority Data
Apr. 26, 2006 (JP) JP2006-121810

(51) Int. Cl. G03C 5/26

(52) U.S. Cl. 430/434

(57) ABSTRACT

A developer used for developing a planographic printing plate material is disclosed and the developer is an alkaline solution comprising a compound represented by formula:

R₁—O—(R₂—O)ₙ—H

wherein R₁ is a branched alkyl group having carbon atoms of not more than 20 which may be interrupted by —NH—; R₂ is an alkylene group having carbon atoms of 1 to 10; and n is an integer of 2 to 100. There is also disclosed a method of processing a planographic printing plate material with the developer.

This application claims priority from Japanese Patent Application No. 2006-121810 filed on Apr. 26, 2006, which is incorporated hereinto by reference.

### FIELD OF THE INVENTION

The present invention is related to a developer used for photosensitive planographic printing plate materials (which are hereinafter also denoted as planographic printing plate materials) and a processing method thereof.

### BACKGROUND OF THE INVENTION

There are known planographic printing plate materials comprising a surface-hydrophilized support provided thereon with a photopolymerizable light-sensitive layer and a protective layer. Specifically for prompt preparation of a high-resolution printing plate and achievement of filmless plate-making, there have been broadly employed a method for preparing planographic printing plates, in which digital exposure based on image data is carried out using a laser, followed by development. For instance, there is known a plate-making system in which a light source is modulated based on output signals from an electronic plate-making system or an image processing system, or image signals transferred through a communication line, whereby a photosensitive material is directly subjected to scanning exposure to prepare a printing plate.

In printing plate materials for use in CTP (computer-to-plate) to record digital data by laser, for example, enhanced speed is desired for shortening the recording time. Enhance plate life is also desirable in various printing fields including newspaper printing and commercial printing such as advertising prints.

As is generally known, the photopolymerizable photosensitive layer described above contains an acryl monomer, an alkali-soluble resin, a photopolymerization initiator, and optionally a sensitizing dye to suit the wavelength in laser writing-in. It is also known to provide a protective layer to prevent polymerization inhibition due to oxygen.

Visible light sources of longer wavelengths, such as Ar laser (488 nm) and FD-YAG laser (532 nm) are employable as a light source to expose a photopolymerization type planographic printing plate material used for plate-making. Recently, a continuous-wave laser in the wavelength region of 350 to 450 nm, using InGaN type or ZnS type materials has now entered the stage of practical use. A scanning exposure system using such a light source of a short wavelength has advantages that a semiconductor laser can be manufactured at a relatively low cost in terms of structure and an economical system with a sufficient output can be realized. Such a light source may be usable for planographic printing plate materials which are sensitive to the shorter wavelength region and workable under a lighter safe light, compared to a conventional system using a FD-YAG laser or an Ar laser.

A photopolymerization type planographic printing plate material is usually subjected to imagewise exposure and optionally to a heating treatment, followed by washing to remove a protective layer, development to remove unexposed areas, a washing treatment and a finisher gum treatment to make non-imaged areas hydrophilic, whereby a planographic printing plate is obtained. Heating after imagewise exposure promotes polymerization, resulting in enhanced sensitivity and longer plate life.

The light-sensitive layer of a conventional positive-type planographic printing plate material uses an ortho-quinonediazide compound in combination with a novolac resin and an aqueous alkaline silicate solution capable of dissolving such a novolac resin is used as a developing solution. A novolac resin is soluble at a pH of about 13. However, a developing solution of such a high pH is toxic when adhered to skin or mucous membrane, necessitating sufficiently careful treatment. Further, in dots of a small image area (small dots), aluminum under the small dots is dissolved through side-etching, resulting in missing of such small dots in printing, further leading to deteriorated plate life and printing quality.

As a developer used for planographic printing plate materials, there is generally used an aqueous alkaline developing solution exhibiting a pH of 12.5 or more. However, a developing solution of a lower pH is desired in terms of workability, safety and eco-management.

Disclosed as an alkali silicate-free developer of a low pH (a pH lower than 12) are a developer of an aqueous potassium hydroxide solution containing an anionic surfactant, as described in JP-A No. 2000-81711 (hereinafter, the term, JP-A refers to Japanese Patent Application Publication) and a developer of an aqueous alkali metal carbonate solution exhibiting a pH of 8.5 to 11.5, as described in JP-A No. 11-65126.

However, such a developer of a relatively low pH is essentially poor in solubilizing power for a light-sensitive layer, producing problems that in an aged printing plate material, for example, a residual layer or development scum is produced due to under-development.

### SUMMARY OF THE INVENTION

The present invention has come into being in light of the foregoing problems. It is an object of the invention to provide a developer used for planographic printing plate materials and exhibiting superior developability and inhibiting staining of the printing plate surface, due to sludge accumulated in the developing bath, and a processing method of a planographic printing plate material.

One aspect of the invention is directed to a developer, used for development of an exposed planographic printing plate material., wherein the developer is an alkaline solution comprising a compound represented by the formula (1):

R₁—O—(R₂—O)ₙ—H (1)

wherein R₁ is a branched alkyl group having carbon atoms of not more than 20 which may be interrupted by —NH—; R₂ is an alkylene group having carbon atoms of 1 to 10; and n is an integer of 2 to 100, provided that plural R₂s may be the same or different.

6. Another aspect of the invention is directed to a processing method of a light-sensitive planographic printing plate material as described above, wherein the planographic printing plate material is imagewise exposed and then developed by the developer described above.

### DETAILED DESCRIPTION OF THE INVENTION

In a conventional developer for light-sensitive planographic printing plates (which is hereinafter also denoted simply as a developer) and a processing method by use thereof, in which a planographic printing plate material having a light-sensitive layer and a thermo-sensitive layer is exposed to laser light and processed in the steps of development, washing and finishing, a so-called residual layer which corresponds to an incompletely hardened portion formed through exposure remains near the image area of the light-sensitive layer, resulting in lowering of plate life and staining of the printing plate surface.

Current developers contain nonionic surfactants for enhancement of the power to dissolve a light-sensitive layer. However, such surfactants include a lipophilic portion having a relatively large molecular weight, which impedes permeability, resulting in incomplete removal of a residual layer formed near an image area after exposure.

In the invention, addition of a nonionic surfactant containing an alkyl group moiety having a low number of carbon atoms and at least one branched chain to a developer promotes permeability of the developer into the light-sensitive layer and removes a residual layer, leading to enhanced developability and plate life. Such a surfactant is also effective in dispersing materials eluted from the light-sensitive layer, leading to inhibition of minute point staining in non-image areas and prevention of sludge formation.

The above-described effects are effective in all kinds of light-sensitive planographic printing plate materials which use a developer. Such effects are specifically enhanced in a light-sensitive planographic printing plate material comprising on an aluminum support a light-sensitive layer composed of a photopolymerization type light-sensitive resin composition containing an ethylenically unsaturated compound, a photopolymerization initiator and a polymer binder.

Working effects of the invention (developability and plate life) are assumed to be as follows. When titanocene compounds and iron-arene compounds used as a polymerization initiator, and copper phthalocyanine compounds used as a visualizing agent, which are water-insoluble are leached into a developer solution out of the printing plate material, they are precipitated, coagulated or deposited with the elapse of time and accumulated in the processing bath in the form of sludge, which adhere to the surface of the printing plate, causing staining. On the contrary, a nonionic surfactant of the foregoing formula (1) promotes dissolution of water-insoluble constituents of the light-sensitive layer composition, such as a photopolymerization initiator and a visualizing agent in a developer solution, whereby superior development of non-image areas (unexposed areas) is achieved.

On the other hand, a developer exhibiting superior developability for non-image areas, in which a large molecular weight of a lipophilic group contained in a surfactant results in insufficient permeability, forming a residual layer in the vicinity of an image area of the light-sensitive layer, causing lowering of plate life and staining of the printing plate surface. However, the use of a nonionic surfactant of the foregoing formula (1) promotes permeation of a developer in non-image areas, achieving superior development in non-image areas (unexposed areas).

There will be further described a developer and a planographic printing plate material of the invention.

### Developer

### Compound of Formula (1):

One novel aspect of the developer of the invention is an alkaline solution containing a compound of the formula (1) described earlier.

In the formula (1), R₁ is a branched alkyl group having the total number of carbon atoms of not more than 20 which is uninterrupted or interrupted by —NH—; R₂ is an alkylene group having carbon atoms of 1 to 10. The branched alkyl group which is interrupted by —NH— has a branched alkylamine ether structure and is represented by the following formula:

R₃—N—R₄—

wherein R₃ is an alkyl group and R₄ is an alkylene group, provided that the total number of carbon atoms of R₃ and R₄ is 20 or less and at least one of R₃ and R₄ has a branched chain structure.

The foregoing branched alkyl group which is uninterrupted or interrupted by —NH— may be substituted by at least one substituent. Examples of such a substituent include an alkyl group (e.g., methyl, ethyl, propyl, isopropyl, tert-butyl, pentyl, hexyl, octyl, dodecyl, tridecyl, tetradecyl, pentadecyl), a cycloalkyl group (e.g., cyclopentyl, cyclohexyl), an alkenyl group (e.g., vinyl, allyl), an alkynyl group (e.g., ethynyl, propargyl), an aryl group (e.g., phenyl, naphthyl), a heteroaryl group (e.g., furyl, thienyl, pyridyl, pyridazyl, pyrimidyl, piperazyl, triazyl, imidazolyl, pyrazolyl, thiazolyl, benzoimidazolyl, benzoxazolyl, quinazolyl, phthalazyl), a heterocyclic group (e.g., pyrrolidyl, imidazolidyl, morphoryl, oxazolidyl), an alkoxy group (e.g., methoxy, ethoxy, propyloxy, pentyloxy, hexyloxy, octyloxy, dodecyloxy), a cycloalkoxy group (e.g., cyclopentyloxy, cyclohexyloxy), an aryloxy group (e.g., phenoxy, naphthyloxy), an alkylthio group (e.g., methylthio, ethylthio, propylthio, pentylthio, hexylthio, octylthio, dodecylthio), a cycloalkylthio group (e.g., cyclopentylthio, cyclohexylthio), an arylthio group (e.g., phenylthio, naphthylthio), an alkoxycarbonyl group (e.g., methyloxycarbonyl, ethyloxycarbonyl, butyloxycarbonyl, octyloxycarbonyl, dodecyloxycarbonyl), an aryloxycarbonyl group (e.g., phenyloxycarbomyl, naphthyloxycarbonyl), a sulfamoyl group (e.g., aminosulfonyl, methylaminosulfonyl, dimethylaminosulfonyl, butylaminosulfonyl, hexylaminosulfonyl, cyclohexylaminosulfonyl, octylaminosulfonyl, dodecylaminosulfonyl, phenylaminosulfonyl, naphthylamoinosulfonyl, 2-pyridylaminosulfonyl), an acyl group (e.g., acetyl, ethylcarbonyl, propylcarbonyl, pentylcarbonyl, cyclohexylcarbonyl, octylcarbonyl, 2-ethylhexylcarbonyl, dodecylcarbonyl, phenylcarbonyl, naphthylcarbonyl, pyridylcarbonyl), an acyloxy group (e.g., acetyloxy, ethylcarbonyloxy, butylcarbonyloxy, octylcarbonyloxy, dodecylcarbonyloxy, phenylcarbonyloxy), an amido group (e.g., methylcarbonylamino, ethylcarbonylamino, propylcarbonylamino, pentylcarbonylamino, cyclohexylcarbonylamino, 2-ethylhexylcarbonylamino, octylcarbonylamino, dodecylcarbonylamino, phenylcarbonylamino, naphthylcarbonylamino), a carbamoyl group (e.g., aminocarbonyl, methylaminocarbonyl, dimetylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl), an ureido group (e.g., methylureido, ethylureid, pentylureido, cyclohexylureido, octylureido, dodecylureido, phenylureido, naphthylureido, 2-pyridylaminoureido), a sulfinyl group (e.g., methylsulfinyl, ethylsulfinyl, butylsulfinyl, cyclohexylsulfinyl, 2-ethylhexylsulfinyl, dodecylsulfinyl, phenylsulfinyl, naphthylsulfinyl, 2-pyridylsulfinyl), an alkylsulfonyl group (e.g., methylsulfonyl, ethylsulfonyl, butylsulfonyl, cyclohexylsulfonyl, 2-ethylhexylsulfonyl, dodecylsulfonyl), an arylsulfonyl group (e.g., phenylsulfonyl, naphthylsulfonyl, 2-pyridylsulfonyl), an amino group (e.g., amino, ethylamino, dimethylamino, butylamino, cyclopentylamino, 2-ethylhexylamino, dodecylamino, anilino, naphthylamine, 2-pyridylamino), a halogen atom (e.g., fluorine, chlorine, bromine, iodine), a cyano group, a nitro group, and a hydroxy group. These substituents may be further substituted by substituent described above. A plurality of these substituents may combine with each other to form a ring. Of these substituents, an alkyl group is preferred.

In the formula (1), R₁ is a branched alkyl group which is comprised of a main chain and one or more side chains and preferably meets the requirement that the ratio of the number of carbon atoms of the main chain (C₁) to that of total carbon atoms (C₂) of the side chains (C₂), i.e., C₂/C₁ is preferably from 0.05 to 3.0. R₁ is preferably comprised of a main chain having carbon atoms of 3 to 19 and at least one side chain having carbon atoms of 1 to 9.

In the formula (1), R₁ is preferably a branched alkyl group which is interrupted by —NH—.

In the formula (1), R₂ is an alkylene group having carbon atoms of 1 to 10 (preferably 2 to 5, more preferably 2 to 4, and still more preferably 2 or 3) which may be substituted by a substituent. Examples of such a substituent is the same as cited in the foregoing branched alkyl group. Plural R₂s may be the same or different.

In the formula (1), n is an integer of 2 to 100, preferably 2 to 30, more preferably 2 to 20, still more preferably 2 to 15, and further still more preferably 3 to 10.

A compound represented by the formula (1) preferably exhibits an HLB value of 11 to 15. An HLB value of less than 11 increases lipophilicity, resulting in lowering of dispersibility of micelles incorporating a light-sensitive material in a developer. An HLB value of more than 15 results in increased hydrophilicity, producing problems such as lowering of permeability of a developer into a light-sensitive material.

The HLB value refers to a quantitative measure of the emulsification characteristic of a surfactant and numerically indicates the balance of hydrophilicity and lipophilicity, that is, the HLB value is an abbreviation of value of hydrophile and lipophile balance.

The HLB value can be determined according to several empirical equations, as below:

### (1) Polyoxyethylene Type Nonionic Surfactant:

HLB=E/5

where E is a polyoxyethylene content (% by mass), provided that the surfactant contains no other hydrophilic group;

### (2) Polyhydric Alcohol Carboxylic Acid Ester:

HLB=20(1−S/A)

where S is a saponification value and A is an acid value of a carboxylic acid;

### (3) Tall Oil, Pine Oil, Bees Wax and Lanolin Polyhydric Alcohol:

HLB=(E+P)/5

where E is oxyethylene content (% by mass) and P is a polyhydric alcohol content (% by mass);

### (4) Silicone Type Surfactant:

HLB=0.89×[cloud number (A)]

where the cloud number (A)can be determined in the manner that 0.5 g of a surfactant is dissolved in 5 ml of ethanol and a 2% aqueous phenol solution is added dropwise, while being maintained at 25° C.; the end point is the time when the solution becomes turbid and the number of required milliliters of the 2% aqueous phenol solution is defined as the cloud number (A).

In the case of a mixture of surfactant “a” exhibiting an HLB value of HLBa and surfactant “b” exhibiting an HLB value of HLBb,

HLB=[(Wa×HLBa)+(Wb×HLBb)]/(Wa+Wb)

where Wa is a mass fraction of surfactant “a” and Wb is a mass fraction of surfactant “b”. In the invention, the HLB value determined according to the equation of item (1) is used.

Specific examples of compounds represented by the formula (1) are shown below but are not limited to these:

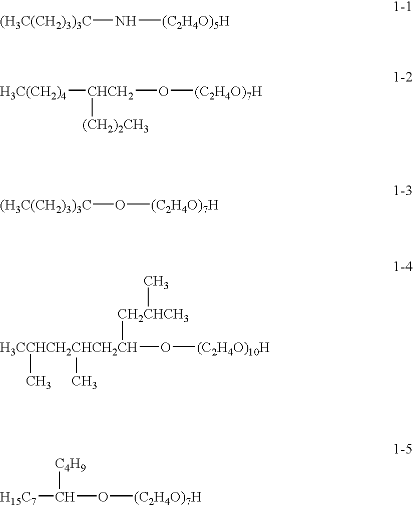

These surfactants are commercially available and can be readily obtained.

A developer (inclusive of a replenisher) of the invention, for use in a processing method of a planographic printing plate material preferably contains, as a main component, at least one compound selected from silicic acid, phosphoric acid, carboxylic acid, boric acid, phenols, oximes and fluorinated alcohols. The developer preferably is an alkaline exhibiting a pH of 8.5 to 13.0.

### Weak Acidic Substance:

Of the foregoing compounds, weakly acidic substances (or weak-acids) such as phenols, saccharides, oximes and fluorinated alcohols are preferably those exhibiting a dissociation exponent (pKa) of 10.0 to 13.2.

Such weak acidic compounds are chosen from those described in IONIZATION CONSTANTS OF ORGANIC ACIDS IN AQUEOUS SOLUTION (Pergamon Press). Specific examples thereof include phenols containing a phenolic hydroxyl group, for example, salicylic acid (13.0), 3-hydroxy-2-naphthoeic acid (12.84), catechol (12.6), gallic acid (12.4), sulfosalicylic acid (11.7), 3,4-dihydroxysulfonic acid (12.2), 3,4-dihydroxybenzoic acid (11.94), 1,2,4-trihydroxybenzene (11.82), hydroquinone (11.56), pyrogallol (11.34), o-cresol (10.33), resorcinol (11.27), p-cresol (10.27) and m-cresol (10.09), in which the numerals in the parentheses are pKa values.

As saccharides are preferably used non-reducing saccharides. Such non-reducing saccharides are saccharides which do not contain an aldehyde group or a ketone group and do not exhibit reducing capability, and are classified into trehalose type oligosaccharides, glycosides with a reducing group attached to a non-saccharide and sugar alcohols obtained by hydrogenation of saccharides, each of which are preferably used in the invention. Oligosaccharides include, for example, saccharose and trehalose, while glycosides include, for example, alkylglycoside, phenol glycoside and mustard oil glycoside. Sugar alcohols include, D,L-arabitol, D,L talitol, dulcitol and alloducitol. There are also suitably used multitol obtained by hydrogenation of disaccharides and a reductant (reducing malt syrup) obtained by hydrogenation of oligosaccharides.

There are also cited oximes such as 2-butanone oxime (PKa: 12.4), acetoxime (12.42), 1,2-cycloheptanedione oxime (12.3), 2-hydroxybenzaldhde oxime (12.10), dimethylglyoxime (11.9), ethanediamide dioxime (11.37) and acetophenone oxime (11.35); and fluorinated alcohols such as 2,2,3,3-tetrafluoropropanol-1 (12.74) and trifluoroethanol (12.37). There are further cited aldehydes such as pyridine-2-aldehyde (12.68) and pyridine-4-aldehyde (12.05); nucleic acid-related compounds such as adenosine (12.56), inosine (12.5), guanine (12.3), cytosine (12.2), hypoxanthine (12.1) and xanthine (11.9); and weak acids such as diethylaminomethylsulfonic acid (12.32), 1-amino-3,3,3-trifluorobenzoic acid (12.29), isopropylidenedisulfonic acid (12.10)1,1-ethylidenediphosphonic acid (11.54)1,1-ethylidenedisulfonic acid-1-hydroxy (11.52), benzimidazole (12.86), thiobenzamide (12.8), picolinethioamide (12.55) and barbituric acid (12.5). In the foregoing, the numeral in the parentheses is a pKa value. These weakly acidic substances may be used alone or in combination. Of these, weak acidic substances of silicic acid, phosphoric acid, carboxylic acid, sulfosalicylic acid and salicylic acid, and non-reducing saccharides of sugar alcohol and saccharose are preferred. Silicic acid, D-sorbitol, saccharose and reducing malt syrup are specifically preferred in terms of exhibiting buffering ability within an appropriate pH region and low price.

These acidic substances are contained preferably in an amount of 0.1% to 30% by mass of the developer, and more preferably 1% to 20% by mass. An amount less than within this range cannot achieve sufficient buffering action and an amount exceeding this region renders it difficult to achieve high concentration and producing problems such as an increases cost.

### Alkali Reagent:

Suitable bases (or alkali reagents) used in combination with the foregoing acids include, for example, sodium hydroxide, ammonium hydroxide, potassium hydroxide and lithium hydroxide. These bases may be used alone or in combination. In the case of a developer exhibiting a pH of not more than 8.5, an imaging area of a printing plate obtained through development of a planographic printing plate material by using such a developer, which is physically weak and easily worn out during printing, cannot achieve sufficient plate life. The imaging area is also chemically weak, for example, an image in a portion wiped with an ink cleaning solvent or a plate cleaner is damaged and cannot achieve sufficient resistance to chemicals. A developer exhibiting a high pH of more than 13.0 is very toxic when adhered to human skin or mucous membrane, necessitating sufficient carefulness in handling.

Other examples of bases or alkali reagents include potassium silicate, sodium silicate, lithium silicate, ammonium silicate, potassium metasilicate, sodium metasilicate, lithium metasilicate, ammonium metasilicate, tripotassium phosphate, trisodium phosphate, trilithium phosphate, triammonium phosphate, dipotassium phosphate, disodium phosphate, dilithium phosphate, diammonium phosphate, potassium carbonate, sodium carbonate, lithium carbonate, ammonium carbonate, potassium hydrogen carbonate, sodium hydrogen carbonate, lithium hydrogen carbonate, ammonium hydrogen carbonate, potassium borate, sodium borate, lithium borate, and ammonium borate. In that, sodium hydroxide, ammonium hydroxide, potassium hydroxide or lithium hydroxide may be added thereto for pH control. In combination with the foregoing alkali reagents, organic alkali reagents may be used, such as monomethylamine, dimethylamine, trimethylamine, monoethylamine, diethylamine, triethylamine, i-propylamine, di-I-propylamine, tri-I-propylamine, i-propanolamine, di-i-propanolamine, ethyleneimine, and pyridine. Of based or alkali reagents described above, potassium silicate or sodium silicate is specifically preferred. The silicate content, which is represent by equivalent converted to SiO₂, is preferably within the range of 1.0% to 3.0% by mass. The molar ratio of SiO₂ to alkali metal M (SiO₂/M) is preferably within the range of 0.25 to 2.

The developers of the invention include not only an unused one to be used at the start of processing but also one to which a replenisher is replenished to compensate developer activity lowered by processing of planographic printing plate material to retain its activity (so-called running developer solution). A replenisher needs to be higher in activity than a running developer, so that the pH of a replenisher may exceed 13.0.

### Surfactant:

In the developer of the invention is used a nonionic surfactant represented by the foregoing formula (1) but in addition thereto, the developer may further use other surfactants such as anionic, cationic, nonionic or amphoteric surfactants.

Nonionic surfactants include, for example, polyoxyethylene alkyl ethers, polyoxyethylene alkylphenyl ethers, polyoxyethylene polystyrylphenyl ethers, polyoxyethylene polyoxypropylene alkyl ethers, glycerin fatty acid partial ester, sorbitan fatty acid partial esters, pentaerythritol fatty acid partial esters, propylene glycol mono-fatty acid esters, sugar fatty acid partial esters, polyoxyethylene sorbitan fatty acid partial esters, polyoxyethylene sorbitol fatty acid partial esters, polyethylene glycol fatty acid partial esters, polyglycerin fatty acid partial esters, polyoxyethylene-modified castor oils, polyoxyethylene glycerin fatty acid partial esters, polyoxyethylene-polyoxypropylene block copolymer, polyoxyethylene-polyoxypropylene block copolymer adduct of ethylene diamine, fatty acid diethanolamides, N,N-bis-2-hydroxyalkylamines, polyoxyethylene alkylamine, triethanolamine fatty acid ester, and trialkylamine oxide.

### Planographic Printing Plate Material

There will be described planographic printing plate materials used in the invention.

### Support:

A support used in the planographic printing plate material of the invention is preferably an aluminum plate, which may be a pure aluminum plate or an aluminum alloy plate.

Various aluminum alloys are usable, including, for example, alloys of aluminum and metals such as silicon, manganese, magnesium, chromium, zinc, lead, bismuth, nickel, titanium, sodium or iron. There are usable aluminum plates manufactured by a variety of rolling methods. There are also usable regenerated aluminum plates obtained by rolling a rerecycled aluminum metal of scrap or recycled materials.

A support used for a planographic printing plate material is preferably subjected to a degreasing treatment to remove rolling oil on the surface, prior to roughening (graining treatment) of the surface. There are employed a degreasing treatment using a solvent such as trichlene or thinner and an emulsion degreasing treatment using emulsion of kerosene, triethanolamine or the like. Aqueous alkaline solutions of caustic soda or the like are usable in a degreasing treatment. The use of aqueous alkaline solutions of caustic soda or the like can remove stains or oxide film which cannot be removed by the above-described degreasing treatments. Aqueous alkaline s of caustic soda or the like, used in a degreasing treatment often form smut and in such cases, t it is preferred to dip the support in an acid such as phosphoric acid, nitric acid, sulfuric acid or chromium acid, or mixed acids to perform de-smutting.

Roughening methods include, for example, mechanical methods and electrolytic etching methods.

Mechanical-roughening methods are not specifically limited but preferred examples thereof include a brushing method and a horning method. Roughening by a brushing method is conducted, for example, in such a manner that while rotating a rotary brush of 10-100 μm thick bristles, the brush is pressed onto the surface of a support with supplying an aqueous slurry of 10-100 μm volcanic ash particles. Roughening by a horning method is carried out, for example, in such a manner that 10-100 μm volcanic ash particles which are homogeneously dispersed in water, are ejected through a nozzle under pressure and collided obliquely onto the surface of a support to roughen the surface. Alternatively, an abrasive sheet in which 10-100 μm abrasive material particles are coated at intervals of 100-200 μm in a density of 2.5×10³ to 10×10³ particles/cm² is adhered to the surface of a support under pressure to transfer a coarse surface pattern.

After completion of roughening by a mechanical-roughening method, as described above, it is preferred to conduct dipping in an acid or base solution to remove any abrasive material buried into the support surface or formed aluminum dust. Examples of an acid usable in the invention include sulfuric acid, peroxosulfuric acid, hydrofluoric acid, phosphoric acid, nitric acid and hydrochloric acid. Examples of a base usable in the invention include sodium hydroxide and potassium hydroxide. Of these, it is preferred to use an alkaline aqueous solution of sodium hydroxide or the like. An aluminum surface is dissolved preferably in an amount of 0.5 to 5 g/m². After completion of dipping in an aqueous alkaline solution, it is preferred to dip it in an acid or mixed acids such as phosphoric acid, nitric acid, sulfuric acid or chromic acid to perform neutralization.

Electrochemically roughening methods are not specifically limited but it is preferred to perform electrochemically roughening in an acidic electrolytic solution. Acidic electrolytic solutions usually used in electrochemically roughening methods are usable and a hydrochloric acid or nitric acid electrolytic solution is preferred. An electrochemically roughening method can be conducted with reference to methods described in, for example, JP-B No. 48-28123 (hereinafter, the term JP-B refers to Japanese Patent Publication), British Patent No. 896,563 and JP-A No. 53-67507. This roughening method is performed by applying a voltage of 1-50 volts (preferably 10-30 volts). The current density is preferably from 10 to 200 A/dm² and more preferably 50 to 150 A/dm². The roughening temperature is preferably 10 to 50° C., and more preferably 15 to 45° C.

When performing electrochemically roughening by use of a nitric acid electrolytic solution, a voltage of 1 to 50 volts is generally applied and preferably, 10 to 30 volts are applied. The current density is preferably within the range of 10 to 200 A/dm² and more preferably, 20 to 100 A/dm². The quantity of electricity is preferably from 100 to 5000 c/dm² and more preferably 100 to 2000 c/dm². The electrochemically roughening temperature is preferably from 10-50° C. and more preferably 15to 45° C. The nitric acid concentration of an electrolytic solution is preferably 0.1-5% by mass. There may optionally be added a nitrate, a chloride, amines, aldehydes, phosphoric acid, chromic acid, boric acid, acetic acid, oxalic acid or the like to the electrolytic solution.

When performing electrochemically roughening by use of a hydrochloric acid electrolytic solution, a voltage of 1 to 50 volts is generally applied and preferably, a voltage of 2 to 30 volts is applied. The current density is preferably within the range of 10 to 200 A/dm² and more preferably, 50 to 150 A/dm². The quantity of electricity is preferably from 100 to 5000 c/dm², more preferably 100 to 2000 c/dm² and still more preferably 200 to 1000 c/dm². The electrochemically roughening temperature is preferably from 10 to 50° C. and more preferably 15 to 45° C. The hydrochloric acid concentration of the electrolytic solution is preferably 0.1% to 5% by mass. There may optionally be added a nitrate, a chloride, amines, aldehydes, phosphoric acid, chromic acid, boric acid, acetic acid, oxalic acid or the like to an electrolytic solution.

After completion of roughening by the electrochemically roughening method described above, it is preferred to conduct dipping in an acid or base solution to remove any abrasive material or aluminum dust attached to the support surface. Examples of an acid usable in the invention include sulfuric acid, peroxosulfuric acid, hydrofluoric acid, phosphoric acid, nitric acid and hydrochloric acid. Examples of a base usable in the invention include sodium hydroxide and potassium hydroxide. Of these, it is preferred to use an alkaline aqueous solution of sodium hydroxide or the like. An aluminum surface is dissolved preferably in an amount of 0.5 to 5 g/m². After completion of dipping in an aqueous alkaline solution, it is preferred to also dip it in an acid or in mixed acids such as phosphoric acid, nitric acid, sulfuric acid or chromic acid to perform neutralization.

Mechanical-roughening or electrochemically roughening may be conducted alone, or subsequent to mechanically roughening, electrochemically roughening may be conducted to achieve roughening.

Subsequent to the roughening treatment, an anodic oxidation treatment is carried out. Anodic oxidation methods applicable in the invention are not specifically limited and commonly known methods are employed. Anodic oxidation forms an oxide layer on the surface of the support. In one preferred embodiment, anodic oxidation is carried out at a current density of 1 to 10 A/dm² in an electrolytic solution containing sulfuric acid and/or phosphoric acid at a concentration of 10-50% by mass. Other methods include electrolysis in sulfuric acid at a high current density, as described in U.S. Pat. No. 1,412,768; electrolysis using phosphoric acid, as described in U.S. Pat. No. 3,511,661; and a method in which at least one of chromic acid, oxalic acid and malonic acid. The oxide layer is formed preferably in an amount of 1 to 50 mg/dm² and more preferably 10 to 40 mg/dm2 . For example, the oxide layer amount can be determined in such a manner that an aluminum plate is immersed in a solution of phosphoric acid and chromic acid (which is prepared by dissolving 35 ml of 85 mass% phosphoric acid and 20 g of chromium oxide in 1 L of water, to dissolve an oxide layer and the amount of the oxide layer can be determined from the mass difference between before and after dissolution of the plate.

An anodically oxidized support may optionally be subjected to a sealing treatment. Such a sealing treatment is conducted by commonly known methods such as a hot water treatment, a boiling water treatment, a steam treatment, an alkali silicate (e.g., sodium silicate) treatment, an aqueous dichromic acid treatment, a nitrite treatment, and an ammonium acetate treatment. After subjected to the foregoing treatments, the support may be treated with poly(vinylphosphonic acid) to cover the surface. Covering treatments are not specifically limited and examples thereof include coating, spraying and dipping. For example, dipping is carried out preferably using an aqueous solution of 0.05% to 3% mass of poly(vinylphosphonic acid) . The treatment is performed preferably at a temperature of 20 to 90° C. over a period of 10 to 180 sec. After completion of the treatment, preferably, a squeegee treatment or a washing treatment is conducted to remove excessive poly(vinylphosphonic acid). A drying treatment is also preferred, preferably at 20 to 95° C. Coverage of poly(vinylphosphonic acid) on the surface of an aluminum support is preferably from 3 to 15 mg/m² and more preferably 3.5 to 10 mg/m². Various combinations of a concentration of aqueous poly(vinylphosphonic acid), treatment temperature and treatment time can achieve a desired coverage.

### Photopolymerization Initiator

Preferred photopolymerization initiators usable in the invention include bromine compounds represented by formula (2) or (3) described below, a titanocene compound, monoalkyltriarylborate compound and iron arene complex compound.

R¹—CBr₂—(C═O)—R² Formula (2)

In the formula (2), R¹ is a hydrogen atom, a bromine atom, an alkyl group, an aryl group, an acyl group, an alkylsulfonyl group, arylsulfonyl group or cyano group; and R² is a monovalent substituent, provided that R¹ and R² may combine with each other to form a ring.

Examples of an alkyl group of R¹ include methyl, ethyl, propyl, isopropyl, tert-butyl, pentyl, hexyl, octyl, dodecyl, tridecyl, tetradecyl, and pentadecyl. Examples of an aryl group include phenyl and naphthyl. Examples of an acyl group include acetyl, ethylcarbonyl, propylcarbonyl, pentylcarbonyl, cyclohexylcarbonyl, octylcarbonyl, 2-ethylhexylcarbonyl, dodecylcarbonyl, phenylcarbonyl, naphthylcarbonyl and pyridylcarbonyl. Examples of an alkylsulfonyl group include methylsulfonyl, ethylsulfonyl, butylsulfonyl, cyclohexylsulfonyl, 2-ethylhexylsulfonyl, and dodecylsulfonyl. Examples of a phenylsulfonyl group include phenylsulfonyl, naphthylsulfonyl, and 2-pyridylsulfonyl.

The monovalent substituent represented by R² is the same as defined in the substituents of a branched alkyl group or a branched alkylamine group of the formula (1) described earlier.

CBr₃—(C═O)—X—R₃ Formula (2)

In the formula (3), R³ is a monovalent substituent, X is —O— or —NR⁴ in which R⁴ is a hydrogen atom or an alkyl group, provided that R³ and R⁴ may combine with each other to form a ring.

A monovalent substituent of R³ is the same as defined in the substituent represented by R². An alkyl group of R⁴ is the same as defined in the alkyl group represented by R¹.

Specific examples of the compound represented by formula (2) or (3) are shown below, but are not limited to these.

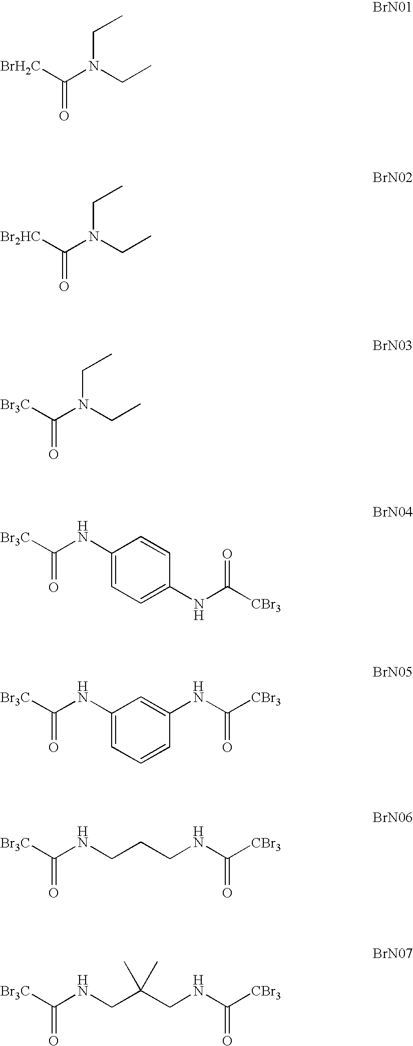

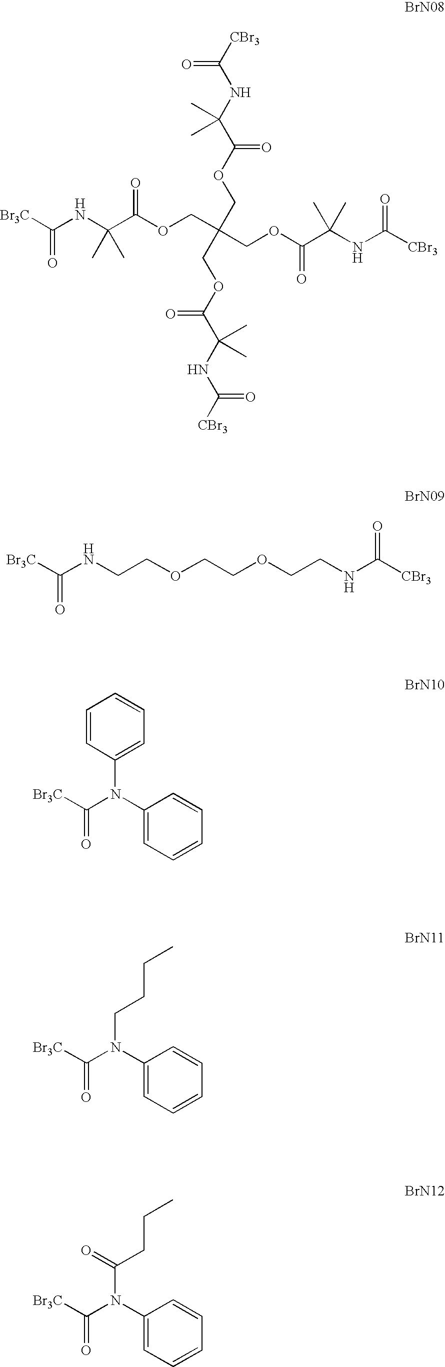

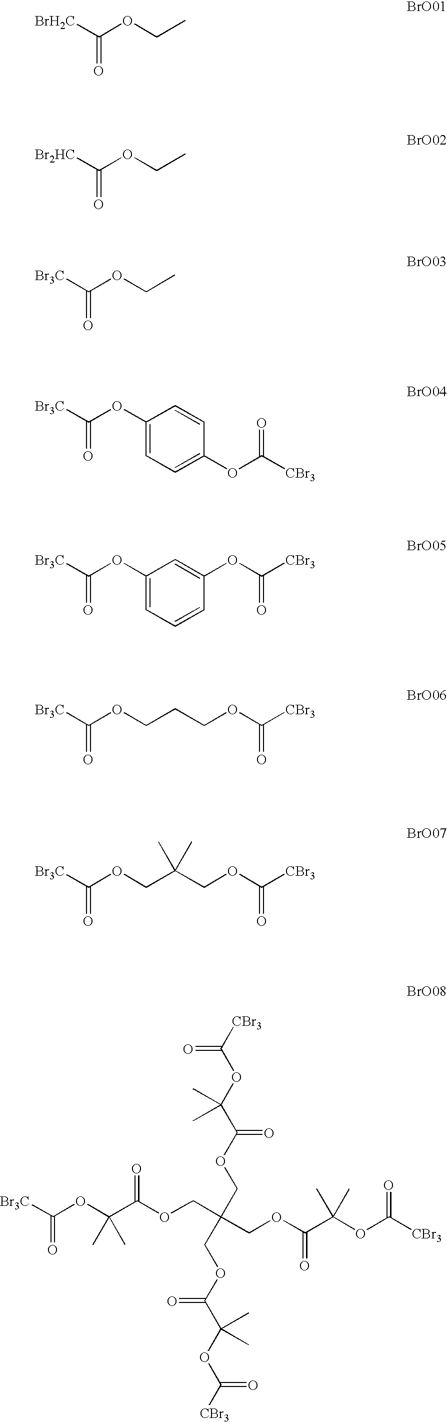

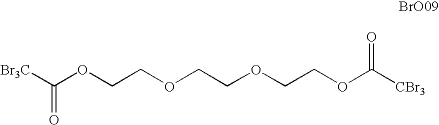

As titanocene compounds are cited those described in JP-A Nos. 63-41483 and 2-291, and specific examples thereof include bis(cyclopentadienyl)-Ti-dichloride, bis(cyclopentadienyl)-Ti-bis-phenyl, bis(cyclopentadienyl)-Ti-bis-2,3,5,6-tetrafluorophenyl, bis(cyclopentadienyl)-Ti-bis-2,3,5,6-tetrafluorophenyl, bis(cyclopentadienyl)-Ti-bis-2,4,6-trifluorophenyl, bis(cyclopentadienyl)-Ti-bis-2,6-difluorophenyl, bis(cyclopentadienyl)-Ti-bis-2,4-difluorophenyl, bis(methylcyclopentadienyl)-Ti-bis-2,3,4,5,6-pentafluorophenyl, bis(methylcyclopentadienyl)Ti-bis-2,3,5,6-tetrafluorophenyl, bis(methylcyclopentadienyl)-Ti-bis2,6-difluorophenyl (IRUGACURE 727L, Ciba Speciality Chemicals Co.), bis(cyclopentadienyl)-bis(2,6-difluoro-3-(pyry-1-yl)phenyl)titanium, bis(cyclopentadienyl)-bis(2,4,6-trifluoro-3-(2,5-dimethylpyry-1-yl)phenyl)titanium.

As monoalkyltriarylborate compounds are cited those described in JP-A Nos. 62-150242 and 62-143044, and specific examples thereof include tetra-n-butylammonium n-butyl-trinaphthalene-1-yl-borate, tetra-n-butylammonium n-butyl-triphenyl-borate, tetra-n-butylammonium, tetra-n-butylammoniumn-butyl-tri-(4-tert-butylphenyl)-borate and tetra-n-butylammonium n-hexyl-tri-(3-fluorophenyl)-borate.

As iron arene complex compounds are cited those described in JP-A No. 59-219307, and specific examples thereof include η-benzene-(η-cyclopentadienyl)iron-hexafluorophosphate, η-cumene-(η-cyclopentadienyl)iron-hexafluorophosphate, η-fluorene-(η-cyclopentadienyl)iron-hexafluorophosphate, η-naphthalene-(η-cyclopentadienyl)iron-hexafluorophosphate, η-xylene-(η-cyclopentadienyl)iron-hexafluorophosphate and η-benzene-(η-cyclopentadienyl)iron-tetrafluoroborate.

There may be used other photopolymerization initiators usable in combination with the foregoing photopolymerization initiators. There are cited, for example, carbonyl compounds, persulfide compounds, redox compounds, azo or diazo compounds, halogen compounds and photoreducible dyes, as described in J. Kosar “Light-sensitive Systems” chapter 5. Specific compounds are disclosed in British Patent No. 1,459,563.

Examples of such photopolymerization initiators usable in combination with the foregoing photopolymerization initiators include benzoin derivatives such as benzoin ether, benzoin isopropyl ether and α,α-dimethoxy-α-phenylacetophenone; benzophenone derivatives such as benzophenone, 2,4-dichlorobenzophenone, methyl o-benzoylbenzoate, and 4,4′-bis(dimethylamino)benzophenone; thioxanthone derivatives such as 2-chlorothioxanthone and 2-I-propylthioxanthone; anthraquinone derivatives such as 2-chloroanthraquinone and 2-methylanthraquinone; acridone derivatives such as N-methylacridone and N-butylacridone; α,α-diethoxyacetophenone, benzyl, fluorenone, xanthone, uranyl compounds; triazine derivatives described in JP-B Nos. 59-1281, 61-9621 and 60-60104; organic peroxides described in JP-A Nos. 59-1504 and 61-243807; diazonium compounds described in JP-B Nos. 43-23684, 44-6413, 47-1604 and U.S. Pat. No. 3,567,453; organic azide compounds described in U.S. Pat. Nos. 2,848,328, 2,852,379 and 2,940,853; o-quinone azides described in JP-B Nos. 36-22062, 37-13109, 38-18015 and 45-9610; onium compounds described in JP-B No. 55-39162, JP-A No. 59-14023 and Macromolecules 10, 1307 (1977); azo compounds described in JP-A No. 59-142205; metal arene complexes described in JP-A No. 1-54440, European Patent Nos. 109,851 and 126,712 and J. Imag. Sci. 30, 174 (1986); (oxo)sulfonium organic boron complexes described in JP-A Nos. 5-213861 and 5-255347; transition metal complexes containing transition metals such ruthenium, as described in Coordination Chemistry Review, 84, 85-277 (1988) and JP-A No. 182701; 2,4,5-triarylimidazole dimers described in JP-A No. 3-209477; tetrabromocarbon, and organic halogen compounds described in JP-A No. 59-107344.

The blending amount of a photopolymerization initiator is not specifically limited but preferably from 0.1 to 20% by mass, based on 100% by mass of addition-polymerizable or curable compound.

When using a laser as a light source, a sensitizing dye is preferably incorporated to a light-sensitive layer. It is preferred to use a dye exhibiting an absorption maximum near the wavelength of a light source.

Examples of compounds capable of sensitizing in the wavelength region from visible to infrared include a cyanine, a phthalocyanine, a merocyanine, a porphyrin, a spiro-compound, a ferrocene, a fluorene, a fulgide, an imidazole, a perylene, a phenazine, a phenothiazine, a polyene, an azo compound, a diphenylmethane, a triphenylmethane, polymethine acridine, a coumalin, a ketocoumalin, a quinacridon, an indigo, a styryl, a pyrylium compound, a pyrromethene compound, a pyrazolotriazole compound, a benzothiazole compound, barbituric acid derivatives, thiobarbituric acid derivatives and a ketoalcohol borate complex. There are also usable compounds described in European Patent No. 568,993, U.S. Patent Nos. 4,508,811 and 5,27,227, and JP-A Nos. 2001-125255 and 11-271969.

Specific examples of a combination of a photopolymerization initiator and a sensitizing dye include combinations described in JP-A Nos. 2001-125255 and 11-271969.

Further, coumalin dyes are usable as a sensitizing dye. The preferred structure of coumalin dyes is represented by the following formula (4):

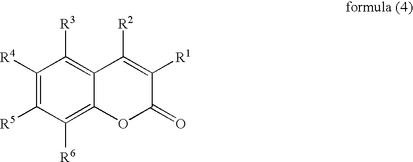

wherein R¹ to R⁶ are each a substituent. Examples of a substituent include an alkyl group (e.g., methyl, ethyl, propyl, isopropyl, tert-butyl, pentyl, hexyl, octyl, dodecyl, tridecyl, tetradecyl, pentadecyl), a cycloalkyl group (e.g., cyclopentyl, cyclohexyl), an alkenyl group (e.g., vinyl, allyl), an alkynyl group (e.g., ethynyl, propargyl), an aryl group (e.g., phenyl, naphthyl), a heteroaryl group (e.g., furyl, thienyl, pyridyl, pyridazyl, pyrimidyl, pyrazyl, triazyl, imidazolyl, pyrazolyl, thiazolyl, benzoimidazolyl, benzoxazolyl, quinazolyl, phthalazyl), a heterocyclic group (e.g., pyrrolidyl, imidazolidyl, morpholyl, oxazolidyl), an alkoxy group (e.g., methoxy, ethoxy, propyloxy, pentyloxy, hexyloxy, octyloxy, dodecyloxy), a cycloalkoxy group (e.g., cyclopentyloxy, cyclohexyloxy), an aryloxy group (e.g., phenoxy, naphthyloxy), an alkylthio group (e.g., methylthio, ethylthio, propylthio, pentylthio, hexylthio, octylthio, dodecylthio), a cycloalkylthio group (e.g., cyclopentylthio, cyclohexylthio), an arylthio group (e.g., phenylthio, naphthylthio), an alkoxycarbonyl group (e.g., methyloxycarbonyl, ethyloxycarbonyl, butyloxycarbonyl, octyloxycarbonyl, dodecyloxycarbonyl), an aryloxycarbonyl group (e.g., phenyloxycarbonyl, naphthyloxycarbonyl), a sulfamoyl group (e.g., aminosulfonyl, methylaminosulfonyl, dimethylaminosulfonyl, butylaminosulfonyl, hexylaminosulfonyl, cyclohexylaminosulfonyl, octylaminosulfonyl, dodecylaminosulfonyl, phenylaminosulfonyl, naphthylaminosulfonyl, 2-pyridylaminosulfonyl), an acyl group (e.g., acetyl, ethylcarbonyl, propylcarbonyl, pentylcarbonyl, cyclohexylcarbonyl, octylcarbonyl, 2-ethylhexylcarbonyl, dodecylcarbonyl, phenylcarbonyl, naphthylcarbonyl, pyridylcarbonyl), an acyloxy group (e.g., acetyloxy, ethylcarbonyloxy, butylcarbonyloxy, octylcarbonyloxy, dodecylcarbonyloxy, phenylcarbonyloxy), an amido group (e.g., methylcarbonylamino, ethylcarbonylamino, dimethylaminocarbonyl, propylcarbonylamino, pentylcarbonylamino, cyclohexylcarbonylamino, 2-ethylhexylcarbonylamino, octylcarbonylamino, dodecylcarbonylamino, phenylcarbonylamino, naphthylcarbonylamino), a carbamoyl group (e.g., aminocarbonyl, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl), an ureido group (e.g., methylureido, ethylureido, pentylureido, cyclohexylureido, octylureido, dodecylureido, phenylureido, naphthylureido, 2-pyridylureido), a sufinyl group (e.g., methylsulfinyl, ethylsulfinyl, butylsulfinyl, cyclohexylsulfinyl, 2-ethylhexylsulfinyl, dodecylsulfinyl, phenylsulfinyl, naphthylsulfinyl, 2-pyridylsulfinyl), an alkylsulfonyl group (e.g., methylsulfonyl, ethylsulfonyl, butylsulfonyl, cyclohexylsulfonyl, 2-ethylhexylsulfonyl, dodecylsulfinyl), an arylsulfonyl group (e.g., phenylsulfonyl, naphthylsulfonyl, 2-pyridylsulfonyl), an amino group (e.g., amino, ethylamino, dimethylamino, butylamino, cyclopentylamino, 2-ethylhexylamino, dodecylamino, anilino, naphthylamine, 2-pyridylamino), a halogen atom (e.g., fluorine, chlorine, bromine, iodine), a cyano group, a nitro group, and a hydroxy group. These substituents may be further substituted by substituents described above. A plurality of these substituents may combine with each other to form a ring.

Of these is specifically preferred a coumalin containing, as R⁵, an amino group, an alkylamino group, a dialkylamino group, an arylamino group, a diarylamino group or an alkylarylamino group. In that case, a coumalin in which an alkyl group substituted for an amino group combines with a substituent of R⁴ or R⁶ is also preferred.

More preferably, one of R¹ and R² or both of them are an alkyl group (e.g., methyl, ethyl, propyl, isopropyl, tert-butyl, pentyl, hexyl, octyl, dodecyl, tridecyl, tetradecyl, pentadecyl), a cycloalkyl group (e.g., cyclopentyl, cyclohexyl), an alkenyl group (e.g., vinyl, allyl), an alkynyl group (e.g., ethynyl, propargyl), an aryl group (e.g., phenyl, naphthyl), a heteroaryl group (e.g., furyl, thienyl, pyridyl, pyridazyl, pyrimidyl, pyrazyl, triazyl, imidazolyl, pyrazolyl, thiazolyl, benzoimidazolyl, benzoxazolyl, quinazolyl, phthalazyl), a heterocyclic group (e.g., pyrroliclyl, imidazolidyl, morpholyl, oxazolidyl), an alkoxycarbonyl group (e.g., methyloxycarbonyl, ethyloxycarbonyl, butyloxycarbonyl, octyloxycarbonyl, dodecyloxycarbonyl), an aryloxycarbonyl group (e.g., phenyloxycarbonyl, naphthyloxycarbonyl), an acyl group (e.g., acetyl, ethylcarbonyl, propylcarbonyl, pentylcarbonyl, cyclohexylcarbonyl, octylcarbonyl, 2-ethylhexylcarbonyl, dodecylcarbonyl, phenylcarbonyl, naphthylcarbonyl, pyridylcarbonyl), an acyloxy group (e.g., acetyloxy, ethylcarbonyloxy, butylcarbonyloxy, octylcarbonyloxy, dodecylcarbonyloxy, phenylcarbonyloxy), a carbamoyl group (e.g., aminocarbonyl, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl), a sulfinyl group (e.g., methylsulfinyl, ethylsulfinyl, butylsulfinyl, cyclohexylsulfinyl, 2-ethylhexylsulfinyl, dodecylsulfinyl, phenylsulfinyl, naphthylsulfinyl, 2-pyridylsulfinyl), an alkylsulfonyl group (e.g., methylsulfonyl, ethylsulfonyl, butylsulfonyl, cyclohexylsulfonyl, 2-ethylhexylsulfonyl, dodecylsulfinyl), an arylsulfonyl group (e.g., phenylsulfonyl, naphthylsulfonyl, 2-pyridylsulfonyl), a halogen atom (e.g., fluorine, chlorine, bromine, iodine), a cyano group, a nitro group or a halogenated alkyl group (e.g., trifluoromethyl, tribromomethyl, trichloromethyl).

Specific examples of a preferred coumalin dye are shown below but are not limited to these.

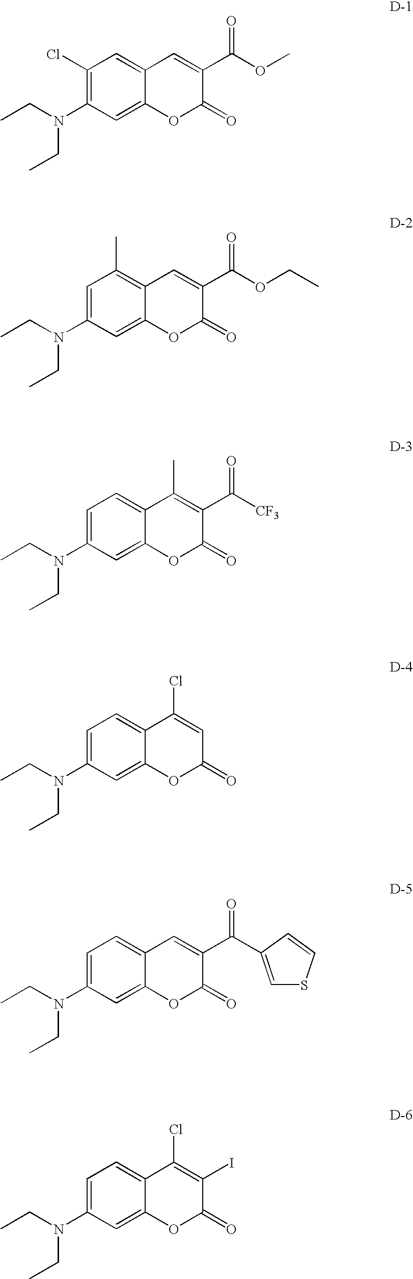

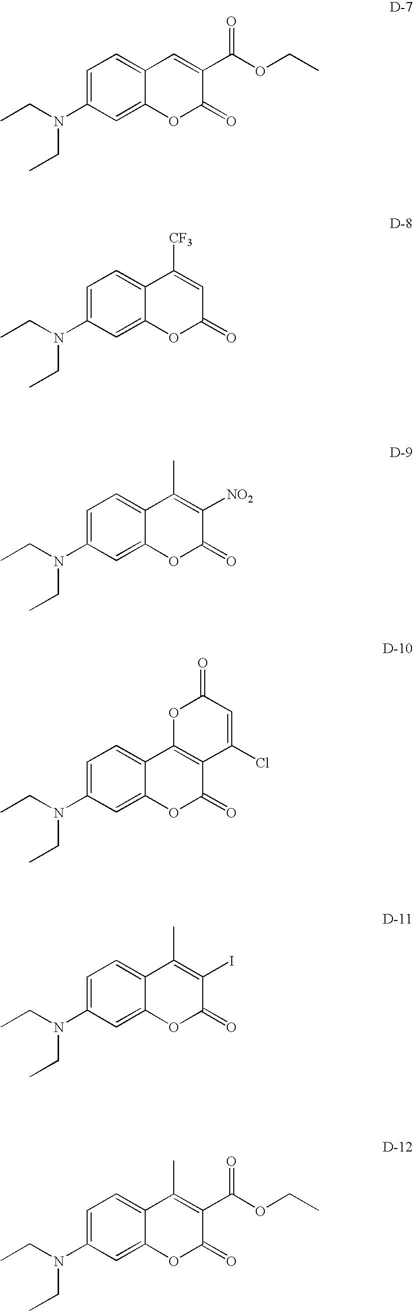

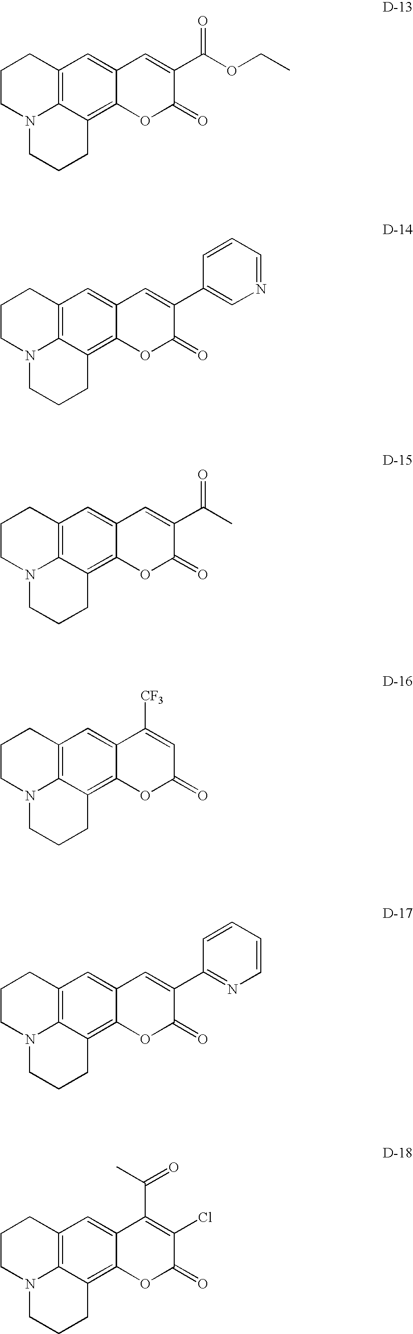

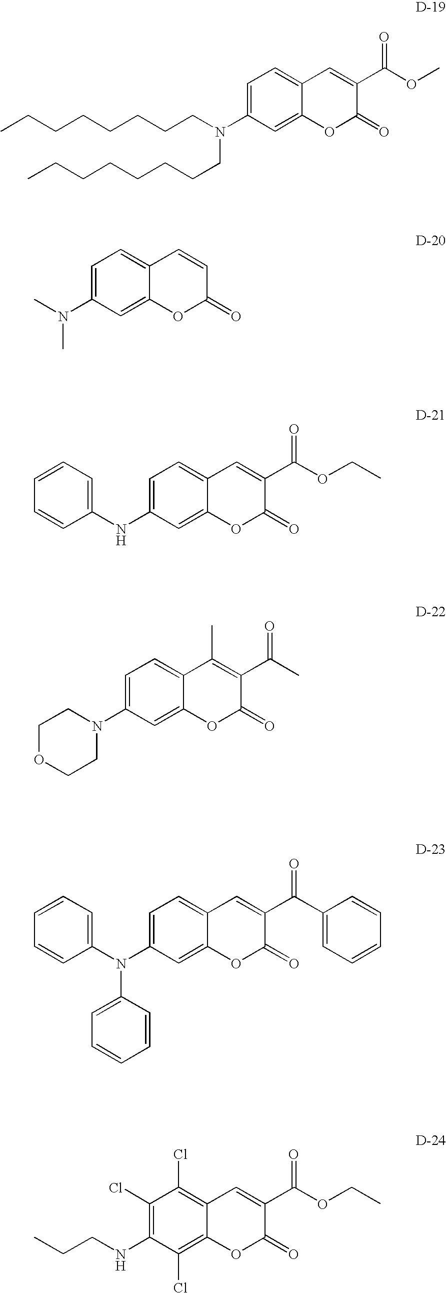

In addition to the foregoing examples, there are also preferably used coumalin derivatives of B-1 through B-22 described in JP-A No. 8-129285; coumalin derivatives of D-1 through D-32 described in JP-A No. 2003-21901; coumalin derivatives of 1 through 21 described in JP-A No. 2002-363206; coumalin derivatives of 1 through 4 described in JP-A No. 2002-363207; coumalin derivatives of 1 through 34 described in JP-A No. 2002-363208; and coumalin derivatives of 1 through 56 described in JP-A No. 2002-363209.

A coumalin dye used as a sensitizing dye is incorporated to a light-sensitive layer preferably in an amount capable of giving a reflection density of the printing plate surface of 0.1 to 1.2 at the wavelengths of a recording light source. The weight ratio of a sensitizing dye in a light-sensitive layer, depending on a molecular absorption coefficient of the dye and a degree of crystallinity in the light-sensitive layer is preferably in the range of 0.5 to 10% by mass.

The molar ratio of a photopolymerization initiator to a sensitizing dye is preferably in the range of from 1:100 to 100:1.

### Ethylenically Unsaturated Monomer

Ethylenically unsaturated compounds capable of addition polymerization, relating to the invention include radical-polymerizable monomers, polyfunctional monomers containing plural ethylenical double bonds within the molecule which are generally used in ultraviolet-curing resin and polyfunctional oligomers. These compounds are not specifically limited but preferred compounds are monofunctional acrylic acid esters such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryloxyethyl acrylate, tetrahydrofurfuryloxyhexanolide acrylate, acrylate of ε-caprolactam of 1,3-dioxane alcohol and 1,3-dioxolan acrylate; methacrylic acid, itaconic acid, crotonic acid and maleic acid esters obtained by replacing the foregoing acrylates by methacrylate, itaconate, crotonate, or maleate, e.g., ethylene glycol diacrylate, triethylene glycol diacrylate, pentaerythritol diacrylate, hydroquinone diacrylate, resorcin diacrylate, hexanediol diacrylate, neo-pentyl glycol diacrylate, tripropylene glycol diacrylate, diacrylate of hydroxypivalic acid neo-pentylglycol, diacrylate of neo-pentylglycol adipate, diacrylate of ε-caprolactam of hydroxypivalic acid neo-pentyl glycol, 2-(2-hydroxy-1,1-dimethylethyl)-5-hydroxymethyl-5-ethyl-1,3-dioxane diacrylate, tricyclodecanedimethylol acrylate, and diacrylate of diglycidyl ether of 1,6-hexanediol; methacrylic acid, itaconic acid, crotonic acid and maleic acid esters obtained by replacing the foregoing acrylates by methacrylate, itaconate, crotonate, or maleate, e.g., polyfunctional acrylic acid ester acid such as trimethylolpropane triacrylateditrimethylopropane tetraacrylate, trimethyloethane triacrylate, pentaerythritol triacrylate, pentaerythritol tetraacrylate, dipentaerythritol tetraacrylate, dipentaerythritol pentaacrylate, dipentaerythritol hexaacrylate, ε-caprolactam of dipentaerythritol hexaacrylate, pyrogallol triacrylate, propionic acid/dipentaerythritol triacrylate, propionic acid/dipentaerythritol tetraacrylate and hydroxypivalylaldehyde-modified dimethylolpropane triacrylate and esters of methacrylic acid, itaconic acid crotonic acid or maleic acid, obtained by replacing these acrylates by methacrylate, itaconate, crotonate or maleate.

Similarly to the foregoing, prepolymers are also usable. As a prepolymer are cited compounds as described below but a prepolymer in which acrylic acid or methacrylic acid is introduced into an oligomer having an appropriate molecular weight to provide photopolymerizability, is also suitably usable. These prepolymers may be used alone or in combination. Alternatively, monomers described above and oligomers may be used in a mixture.

Examples of prepolymers include polyester acrylates obtained by introducing (meth)acrylic acid into a polyester obtained by the combination of a polybasic acid and a polyhydric alcohol, for example, polybasic acids such as adipic acid, trimellitic acid, maleic acid, phthalic acid, terephthalic acid, hymic acid, malonic acid, succinic acid, glutaric acid, itaconic acid, pyromellitic acid, fumaric acid, pimelic acid, cebacic acid, dodecanoic acid or tetrahydrophthalic acid and polyhydric alcohols such as ethylene glycol, propylene glycol, diethylene glycol, propylene oxide, 1,4-butanediol, triethylene glycol, tetraethylene glycol, polyethylene glycol, glycerin, trimethylolpropane, pentaerythritol, sorbitol, or 1,6-hexanediol, 1,2,6-hexanetriol; epoxyacrylate in which (meta)acrylic acid is introduced into an epoxy resin, such as bisphenol A/epichlorohydrin/(meta)acrylic acid and phenol novolac/epichlorohydrin/(meta)acrylic acid; urethane acrylate in which (meta)acrylic acid is introduced into urethane resin, such as ethylene glycol/adipic acid/tolylenediisocyanate/2-2-hydroxyethyl acrylate, polyethylene glycol/tolylenediisocyanate-2-hydroxyethyl acrylate, hydroxyethylphthalyl methacrylate/xylenediisocyanate, 1,2-polybutadiene glycol/tolylene diisocyanate/2-hydroxyethyl acrylate, or trimethylolpropane/propylene glycol/tolylene diisocyanate/2-hydroxyethyl acrylate; silicone resin acrylates such as polysiloxane acrylate or polysiloxane/diisocyanate/2-hydroxyethyl acrylate; alkyd-modified acrylates in which (meta)acryloyl group is introduced into an oil-modified alkyd resin; and spirane resin acrylates.

The light-sensitive composition can contain a monomer such as phosphazene monomer, triethylene glycol, isocyanuric acid ethylene oxide (EO)-modified diacrylate, isocyanuric acid ethylene oxide (EO)-modified triacrylate, trimethylolpropane acrylic acid benzoic acid ester, alkylene glycol type acrylic acid0modification, and urethane-modified acrylate, and addition-polymerizable oligomer or prepolymers containing a constituting unit formed of the foregoing monomers.

As an ethylenic monomer usable in combination is cited a phosphoric acid ester compound containing at least one (meta)acryloyl group. This compound is one in which at least a part of hydroxyl groups of phosphoric acid is esterified and is not specifically limited so long as a (meta)acryloyl group is contained.

There are also usable compounds described in JP-A Nos. 58-212994, 61-6649, 62-46688, 62-48589, 62-173295, 62-187092, 63-67189 and 1-244891. Further, compounds described in “Chemical Goods of 11290” Kagakukogyo Nippo-sha, page 286-294, and “UV/EB Curing Handbook (Raw Material)” Kobunshi Kankokai page 11-65 are also suitably usable. Of these, a compound containing at least two acryl groups or methacryl groups within the molecule is preferred in the invention, and one having a molecular weight of not more than 10,000 (more preferably, not more than 5,000) is preferred.

In the invention, it is preferred to use polymerizable ethylenically unsaturated monomer which contains a tertiary amino group within the molecule. Such a compound is not limited in structure but it is preferred to use a hydroxy-containing tertiary amine compound which is modified with glycidyl methacrylate, methacrylic acid chloride or acrylic acid chloride. Specifically polymerizable compounds described JP-A Nos. 1-165613, 1-203413 and 1-197213 are preferred.

In the invention, it is preferred to use a reaction product of a polyhydric alcohol containing a tertiary amino group in the molecule, a diisocyanate compound and a polymerizable, ethylenically unsaturated compound containing a hydroxyl group in the molecule.

Specific examples of polyhydric alcohol containing a tertiary amino group in the molecule include triethanolamine, N-methyldiethanolamine, N-ethyldiethanolamine, N-n-butyldiethanolamine, N-tert-butyldiethanolamine, N,N-di(hydroxyethyl)aniline, N,N,N′,N′-tetra-2-hydroxypropylethylenediamine, p-tolyldiethanolamine, N,N,N′,N′-tetra-2-hydroxyethylethylenediamine, N,N-bis(2-hydroxypropyl)aniline, allyldiethanolamine, 3-(dimethylamino)-1,2-propanediol, 3-diethylamino-1,2-propanediol, N,N-di(n-propyl)amino-2,3-propanediol, N,N-di(iso-propyl)amino-2,3-propanediol, and 3-(N-methyl-N-benzylamino)-1,2-propanediol, but are not limited to these.

Specific examples of a diisocyanate compound include butane-1,4-diisocyanate, haxane-1,6-diisocyanate, 2-methylpenetane-1,5-diisocyanate, octane-1,8-diisocyanate, 1,3-diisocyanatemethyl-cyclohexanone, 2,2,4-trimethylhexane-1,6-diisocyanate, isophorone diisocyanate, 1,2-phenylenediisocyanate, 1,3-phenylenediisocyanate, 1,4-phenylenediisocyanate, tolylene-2,4-diisocyanate, tolylene-2,5-diisocyanate, tolylene-2,6-diisocyanate, 1,3-di(isocyanatemethyl)benzene and 1,3-bis(1-isocyanate-1-methyethyl)benzene, but are not limited to these. Preferred examples of a polymerizable, ethylenically unsaturated compound which contains a hydroxyl group in the molecule include 2-hydroxyethyl methacrylate, 4-hydroxybutyl acrylate, 2-hydroxypropylene-1,3-dimethacrylate and 2-hydroxypropylene-1-methacrylate-3-acrylate.

The reaction of the foregoing compounds is a conventional reaction of a diol compound, a diisocyanate compound and a hydroxyl group-containing acrylate compound and is conducted similarly to synthesis of an urethane acrylate.

Specific examples of a reaction product of a polyhydric alcohol containing a tertiary amino group in the molecule, a diisocyanate compound and a polymerizable, ethylenically unsaturated compound containing a hydroxyl group in the molecule are shown below:
M-1: reaction product of triethanolamine (1 mol), hexane-1,6-diisocyanate (3 mol) and 2-hydroxyethylmetacrylate (3 mol),
M-2: reaction product of triethanolamine (1 mol), isophoronediisocyanate (3 mol) and 2-hydroxy-ethylacrylate (3 mol),
M-3: reaction product of N-n-butylethanolamine (1 mol), 1,3-bis(l-isocyanato-1-methylethyl)benzene (2 mol) and 2-hydroxypropylene-1-methacrylate-3-acrylate (2 mol),
M-4: reaction product of N-n-butyldiethanolamine (1 mol), 1,3-di(isocyanatomethyl)benzene (2 mol) and 2-hydroxypropylene-1-methacrylate-3-acrylate (2 mol),
M-5 N-methyldiethanolamine (1 mol), tolylene-2,4-diisocyanate (2 mol) and 2-hydroxypropylene-1,3-dimeihacrylate (2 mol).

There are also usable acrylates or alkyl acrylates described in JP-A Nos. 1-105238 and 2-127404.

### Polymeric Binder Material

The planographic printing plate material relating to the invention contains a polymeric binder material in the photopolymerizable light-sensitive layer.

There are usable, as a polymeric binder material, an acrylic polymer, a polyvinylbutyral resin, polyurethane resin, polyamide resin, polyester resin, an epoxy resin, a phenol resin, a polycarbonate resin, polyvinyl butyral resin, polyvinyl formal resin, shellac and natural resins. These resins may be used in combination.

A vinyl copolymer obtained by copolymerization of vinyl monomers is preferred. A copolymer of (a) a carboxyl group-containing monomer and (b) an alkyl methacrylate or alkyl acrylate, as copolymerization composition of a polymeric binder material is more preferred.

Specific examples of a carboxyl group-containing monomer include α,β-unsaturated carboxylic acids such as acrylic acid, methacrylic acid, maleic acid anhydride, itaconic acid and itaconic acid anhydride. Further, a carboxylic acid such as a half ester of phthalic acid and 2-hydroxymethacrylate is also preferred.

Specific examples of an alkyl methacrylate and an alkyl acrylate include unsubstituted alkyl esters such as methyl methacrylate, ethyl methacrylate, propyl methacrylate, butyl methacrylate, amyl methacrylate, hexyl methacrylate, heptyl methacrylate, octyl methacrylate, nonyl methacrylate, decyl methacrylate, undecyl methacrylate, methyl acrylate, ethyl acrylate, propyl acrylate, butyl acrylate, amyl acrylate, hexyl acrylate, heptyl acrylate, octyl acrylate, nonyl acrylate, decyl acrylate, undecyl acrylate and dodecyl acrylate; cyclic alkyl esters such a cyclohexyl methacrylate and cyclohexyl acrylate; substituted alkyl esters such as 2-chloroethyl methacrylate, N,N-dimethylaminoethyl methacrylate, glycidyl methacrylate, benzyl acrylate, 2-chloroethyl acrylate, N,N-dimethylaminoethyl acrylate and glycidyl acrylate.

Further, a polymeric binder material can use, as a copolymerizable monomer, monomers (1) to (14), as described below:
(1) monomer containing an aromatic hydroxyl group, for example, o-(or p- or m-)hydroxystyrene and o-(or p- or m-)hydroxyphenylacrylate;
(2) monomer containing an aliphatic hydroxyl group, for example, 2-hydroxyethylacrylate, 2-hydroxyethylmethacrylate, N-methylolacrylamide, N-methylolmethacrylamide, 4-hydroxybutylmethacrylate, 5-hydroxypentylacrylate, 5-hydroxypentylmethacrylate, 6-hydroxyhexylacrylate, 6-hydroxyhexylmetacrylate, N-(2-hydroxyethyl)acrylamide, N-(2-hydroxyethyl)metacrylamide, and hydroethyl vinyl ether;
(3) monomer containing an aminosulfonyl group, for example, m-(or p-)aminosulfonylphenyl methacrylate, m-(or p-)aminosulfonylphenyl acrylate, N-(p-aminosulfonylphenyl)methacrylamide, N-(p-aminosulfonylphenyl)acrylamide;
(4) monomer containing a sulfonamido group, for example, N-(p-toluenesulfonyl)acrylamide, N-(p-toluenesulfonyl)methacrylamide;
(5) acrylamides or methacrylamides: for example, acrylamide, methacylamide, N-ethylacrylamide, N-hexylacrylamide, N-cyclohexylacrylamide, N-phenylacrylamide, N-(4-nitrophenyl)acrylamide, N-ethyl-N-phenylacrylamide, N-(4-hydroxyphenyl)acrylamide, N-(4-hydroxyphenyl)methacrylamide;
(6) monomer containing a fluoroalkyl group, for example, trifluoroethyl acrylate, trifluoroethyl methacrylate, tetrafluoropropyl methacrylate, hexafluoropropyl methacrylate, octafluoropentyl acrylate, octafluoropentyl methacrylate, heptadecafluorodecyl methacrylate, N-butyl-N-(2-acryloxyethyl)heptadecafluorooctylsulfoneamide;
(7) vinyl ethers, for example, ethyl vinyl ether, 2-chloroethyl vinyl ether, propyl vinyl ether, butyl vinyl ether, octyl vinyl ether, phenyl vinyl ether;
(8) vinyl esters, for example, vinyl acetate, vinyl chloroacetate, vinyl butyrate, vinyl benzoate;
(9) styrenes, for example, styrene, methylstyrene, chloromethylstyrene,
(10) vinyl ketones, for example, methyl vinyl ketone, ethyl vinyl ketone, propyl vinyl ketone, phenyl vinyl ketone;
(11) olefins, for example, ethylene, propylene, I-butylene, butadiene, isoprene;
(12) N-vinylpyrrolidone, N-vinylcarbazol, 4-vinylpyridine
(13) monomer containing a cyano group, for example, acrylonitrile, methacrylonitrile, 2-pentenenitrile, 2-methyl-3-butenenitrile, 2-cyanoethyl acrylate, o-(or m- or p-)cyanostyrene;
(14) monomer containing an amino group, for example, N,N-diethylaminoethyl methacrylate, N,N-dimethylaminoethyl acrylate, N,N-dimethylaminoethyl methacrylate, polybutadieneurethane acrylate, N,N-dimethylaminopropylacrylamide, N,N-dimethylacrylamide, acryloyl morpholine, N-N-propylacrylamide, N,N-diethylacrylamide.

Further, other monomers which are copolymerizable with the foregoing monomers, may be copolymerized.

An unsaturated bond-containing vinyl copolymer which is obtained by reacting a compound containing an acryloyl group and an epoxy group with the carboxyl group contained in the vinyl copolymer described above is preferred as a polymeric binder material. Specific examples of such a compound containing an acryloyl group and an epoxy group in the molecule include glycidyl acrylate, glycidyl methacrylate and an epoxy group-containing unsaturated compound described in JP-A No. 11-271969.

These copolymers are preferably those which exhibit 1 to 100,000 of a weight-average molecular weight, determined by gel permeation chromatography (GPC), but are not limited to these ranges.

The content of a polymeric binder material contained of the light-sensitive layer composition is preferably in the range of 10% to 90% by mass, more preferably 15% to 70% by mass, and still more preferably 20% to 50% by mass in terms of sensitivity.

The acid value of a resin is preferably in the range of 10 to 150, more preferably 30 to 120 and still more preferably 50 to 90 in terms of balance of the overall polarity of the light-sensitive layer, thereby preventing coagulation of pigments contained in a light-sensitive layer coating solution.

The coverage of the photopolymerizable light-sensitive layer containing constituents described above is preferably 0.1 to 5 g/m², and more preferably 0.5 to 3 g/m², based on the mass after being dried.

### Oxygen Barrier Layer

The planographic printing plate material relating to the invention is preferably provided with an oxygen-barrier layer (overcoat layer) on the photopolymerizable light-sensitive layer.

Water-soluble polymers capable of forming film exhibiting low oxygen permeability are used for an oxygen barrier layer. Specifically, polyvinyl alcohol or polyvinyl pyrrolidone is contained. Thus, polyvinyl alcohol is effective in inhibiting permeation of oxygen and polyvinyl pyrrolidone is effective in security of adhesion to an adjacent light-sensitive layer.

In addition to the foregoing two kinds of polymers, there may optionally be incorporated water-soluble polymers such as a polysaccharide, polyethylene glycol, gelatin, glue, casein, hydroxycellulose, carboxymethyl cellulose, methyl cellulose, hydcoxyethyl starch, gum arabic, sucrose octaacetate, ammonium alginate, polyvinylamine, polyethylene oxide, poly(styrensulfonic acid), polyacrylic acid, and water-soluble polyamide.

The planographic printing plate material preferably exhibits a peeling power between the light-sensitive layer and the overcoat layer of not less than 0.34 N/cm, more preferably not less than 0.49 N/cm, and still more preferably not less than 0.74 N/cm. A preferred composition of the overcoat layer is disclosed in, for example, JP-A No. 10-10742.

The peeling power can be determined, for instance, in such a manner that a given wide adhesive tape exhibiting sufficient adhesion power is adhered to the overcoat layer and peeled off together with the overcoat layer at an angle of 90° to the surface of the printing plate material to determine the power necessary for peeling-off.

The overcoat may optionally contain a surfactant and a matting agent. The composition of an overcoat layer, as described above is dissolved in an appropriate solvent, coated on the Light-sensitive layer and dried to form an overcoat layer. The main component of such a solvent is preferably water or alcohols such as methanol, ethanol or i-propanol.

The coverage of an overcoat layer is preferably in the range of 0.1 to ca. 10 g/m², based on the mass after being dried, more preferably 0.3 to 5 g/m, and still more preferably 0.5 to ca. 3 g/m².

In the constitution of the invention, there may further be combined plate materials, plate surface-protecting agents, raw materials for developer and automatic processor, as described in, for example, JP-A Nos. 11-065129, 11-065126, 2000-206706, 2000-081711, 2002-091014, 2002-091015, 2002-091016, 2002-091917, 2002-174907, 2002-182401, 2002-196506, 2002-196507, 2001-202616, 2002-229187, 2002-202615, 2002-251019, 2002-365813, 2003-029427, 2003-021908, 2003-015318, 2003-035960, 2003-043693, 2003-043701, 2003-043702 and 2003-043703.

### EXAMPLES

The present invention will be further described with reference to examples but embodiments of the invention are by no means limited to these. In the following examples, unless otherwise noted, “part(s)” and “%” represent part(s) by mass and % by mass, respectively.

### Synthesis of Binder

Into a three-necked flask were placed 30 parts of methacrylic acid, 50 parts of methyl methacrylate, 20 parts of ethyl methacrylate, 500 parts of isopropyl alcohol and 3 parts of α,α-azobisisobutyronitrile and reacted under nitrogen gas stream at 80° C. for a period of 6 hrs. in an oil bath. Thereafter, the reaction mixture was refluxed at the boiling temperature of iso-propyl alcohol for 1 hr., then, 3 parts of trimethylammonium chloride and 25 parts of glycidyl methacrylate were added thereto and allowed to react for 3 hrs. to obtain acryl copolymer 1. The weight average molecular weight which was determined by GPC was 35,000 and the glass transition temperature (Tg) which was determined by differential scanning calorimetry (DSC) was approximately 85° C.

### Preparation of Support

A 0.3 mm thick aluminum plate (material: 1050, thermal refining: H16) was immersed into an aqueous 5% sodium hydroxide solution maintained at 65° C., then subjected to a degreasing treatment for 1 min. and subsequently washed. The thus degreased aluminum plate was then immersed in an aqueous 10% hydrochloric acid solution maintained at 25° C. for 1 min. to allow neutralization and then washed. Subsequently, the aluminum plate was treated in an aqueous 0.3% nitric acid solution at 25° C. for 60 sec. by an alternating current at a current density of 100 A/dm² to perform electrolytic surface-roughening and then subjected to a de-smutting treatment in an aqueous 5% sodium hydroxide solution maintained at 60° C. for 10 sec. The surface-roughened aluminum plate was subjected to an anodic oxidation treatment in a 15% sulfuric acid solution at 25° C. for 1 min. under conditions of a current density of 10 A/dm and a voltage of 15 V and further subjected to a hydrophilization treatment in 1% poly(vinylphosphonic acid) at 75° C. to obtain a support.

The surface of the support exhibited a center-line mean roughness (Ra) of 0.65 ρm.

### Preparation of Printing Plate Material

A coating solution of a photopolymerizable light-sensitive layer of the following composition was coated by a wire-bar on the foregoing support so as to have a dry coverage of 1.5 g/m² and dried at 95° C. for 1.5 min. to obtain a coat sample of a photopolymerizable light-sensitive layer.

### Coating Solution of Light-Sensitive Layer:

| | |
|---|---|
| Polymerizable ethylenically unsaturated | 25.0 parts |
| monomer M3 | |
| Polymerizable ethylenically unsaturated | 25 parts |
| monomer NK Ester 4G (polyethylene glycol | |
| dimethacrylate, produced by Shin-Nakamura | |
| Kagaku Co., Ltd.) | |
| Photopolymerization initiator I-1 | 2.0 parts |
| Photopolymerization initiator I-2 | 2.0 parts |
| Photopolymerization initiator BR22 | 1.0 parts |
| Photopolymerization initiator BR 43 | 1.0 parts |
| Sensitizing dye D-5 | 1.5 parts |
| Sensitizing dye D-7 | 1.5 parts |
| Acryl copolymer | 40.0 parts |
| N-phenylglycine benzyl ester | 4.0 parts |
| Phthalocyanine pigment (MHI 454, | 6.0 parts |
| (produced by Mikuni Shikiso Co.) | |
| 2-t-butyl-6-(3-t-butyl-2-hydroxy-5-meth- | 0.5 parts |
| ylbenzyl)-4-methylphenyl acrylate | |
| (Sumilizer GS, produced by Sumitomo 3M) | |
| Fluorinated surfactant (F-178K, | 0.5 parts |
| produced by Dainippon Ink Co.) | |
| Methyl ethyl ketone | 80 parts |
| Cyclohexanone | 820 parts |

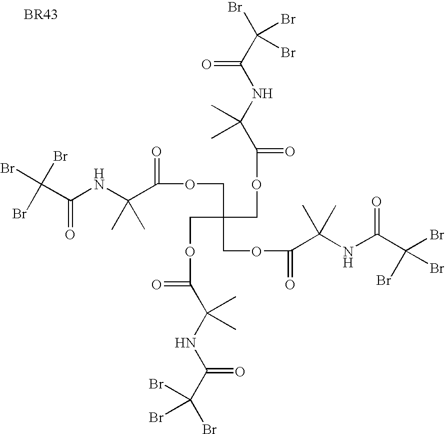

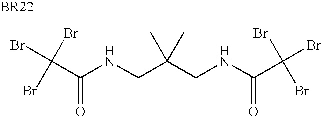

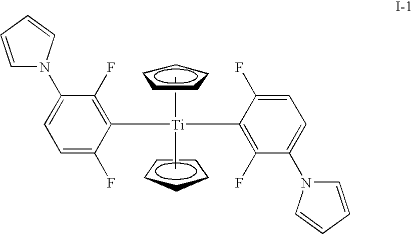

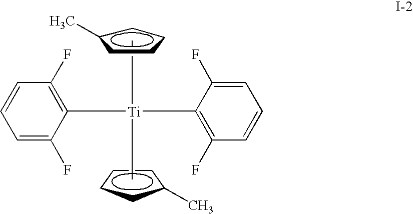

On the foregoing photopolymerizable light-sensitive layer, a coating solution of an oxygen barrier layer of the following composition was coated by an applicator so as to have a dry coverage of 1.8 g/m² and then dried at 75° C. for 1.5 min. to prepare a planographic printing plate material provided with an oxygen layer.

### Coating Solution of Oxygen Barrier Layer:

| | |
|---|---|
| Polyvinyl alcohol (GL-05, produced by | 89 parts |
| Nippon Gosei Kagaku Co.) | |
| Water-soluble polyamide (P-70, | 10 parts |
| produced by Toray) | |
| Surfactant (Surfinol 465, produced | 0.5 parts |
| by Nisshin Kagaku Kogyo Co.) | |
| Water | 900 parts |

### Preparation of Printing Plate

The prepared planographic printing plate material was imagewise exposed at a resolution of 2400 dpi using a CTP exposure apparatus installed with a FD-YAG laser (Tigercat, produced by ECRM Co.), in which an exposure pattern used a 100% image area and 175 LPI 50% square dots. Separately, the printing plate material was similarly imagewise exposed using a plate setter installed with a 408 nm, 30 mW laser (modified Tigercat, produced by ECRM Co.). The thus exposed printing plate materials were each processed with developer a or b by using a CTP automatic processor (PHW32-V, produced by Technigraph Co.) which was provided with a pre-washing section to remove an oxygen barrier layer prior to processing, a development section filled with developer (a) or developer (b), a washing section to remove developer adhered to the printing surface and a gum solution (GW-3, diluted to a factor of two, produced by Mitsubishi Kagaku Co.) to obtain planographic printing plates 1a and 1b from developers (a) and (b), respectively.

### Developer (a):

| | |
|---|---|
| Aqueous potassium silicate | 8.0% |
| (SiO₂ 26% and K₂O 13.5%) | |
| Poloxyethylene(13) naphthyl ether | 3.0% |
| sulfonic acid sodium salt | |
| Nonionic surfactant [polyoxyethylene(5)- | 0.5% |
| tert-tridecylamine ether] | |
| Potassium hydroxide | amount to make a pH 12.3 |
| Water | to make 100% in total |

### Developer (b);

| | |
|---|---|
| Sodium carbonate | 2.5% |
| Sodium hydrogen carbonate | 0.5% |
| Poloxyethylene(13) naphthyl ether | 3.0% |
| sulfonic acid sodium salt | |
| Nonionic surfactant [polyoxyethylene(5)- | 0.5% |
| tert-tridecylamine ether] | |
| Potassium hydroxide | amount to make a pH 10.4 |
| Water | to make 100% in total |

### Preparation of Printing Plates 2a, 2b to 9a and 9b

Printing plates 2a and 2b to 9a and 9b were prepared similarly to the printing plates 1a and 1b, provided that the nonionic surfactant was replaced by the compound shown in

### Table 1.

### Evaluation

### Developability

In 100% image area recorded on the surface of the respective printing plate, after being exposed to the least exposure energy at which no layer reduction was observed and processed, the presence/absence of a residual layer near the image area was visually evaluated.

### Staining in Non-Image Area

The processed printing plates were each rubbed with a PS sponge impregnated with a PS ink (PI-2, produced Fuji Film Co.) and then washed. The plate in which the image area was coated with an ink was observed by a magnifier and minute points of stain in non-image areas, resulting from constituents in the light-sensitive layer were evaluated, based on the number of stain points per 1 m².

### Plate Life

The printing plate material was exposed at 200 μJ/cm² through an image of 175 lines per inch and processed to obtain a planographic printing plate. Using this printing plate, printing was conducted on coated paper by a printing machine (DAIYA 1F-1, produced by Mitsubishi Juukogyo Co., Ltd.) using a printing ink (soybean an oil ink “Naturalist 199”, produced by Dainippon Ink Kagakukogyo Co., Ltd.) and an aqueous dampening liquid (H Liquid SG-51, density: 1.5%, produced by Tokyo Ink Co., Ltd.). Plate life was evaluated based on the number of printed sheets before occurrence of dot loss in a highlight area.

Evaluation results are shown in Table 2.

TABLE 1

| | Nonionic Surfactant | | | | | | | |
|---|---|---|---|---|---|---|---|---|
| | | No. of | | No. of | Presence | | | |
| Developer | | Carbons | | Side | of | | | |
| No. | Compound*¹ | of R₁ | C₁/C₂ | Chains | —NH— | HLB | pH | Remark |
| a1 | 1 | 13 | 1.6 | 2 | Yes | 11.3 | 12.3 | Inv. |
| a2 | 2 | 10 | 0.43 | 1 | No | 13.3 | 12.3 | Inv. |
| a3 | 3 | 13 | 1.6 | 2 | No | 12.2 | 12.3 | Inv. |
| a4 | 4 | 12 | 1.0 | 3 | No | 14.1 | 12.3 | Inv. |
| a5 | 5 | 12 | 0.5 | 1 | No | 12.5 | 12.3 | Inv. |
| a6 | 6 | 13 | 1.6 | 2 | No | 8.0 | 12.3 | Inv. |
| a7 | 7 | 6 | 0.2 | 1 | No | 13.7 | 12.3 | Inv. |
| a8 | 8 | — | — | 0 | No | 14.5 | 12.3 | Comp. |
| a9 | 9 | — | — | 0 | No | 14.8 | 12.3 | Comp. |
| b1 | 1 | 13 | 1.6 | 2 | Yes | 11.3 | 10.4 | Inv. |
| b2 | 2 | 10 | 0.43 | 1 | No | 13.3 | 10.4 | Inv. |
| b3 | 3 | 13 | 1.6 | 2 | No | 12.2 | 10.4 | Inv. |
| b4 | 4 | 12 | 1.0 | 3 | No | 14.1 | 10.4 | Inv. |
| b5 | 5 | 12 | 0.5 | 1 | No | 12.5 | 10.4 | Inv. |
| b6 | 6 | 13 | 1.6 | 2 | No | 8.0 | 10.4 | Inv. |
| b7 | 7 | 6 | 0.2 | 1 | No | 13.7 | 10.4 | Inv. |
| b8 | 8 | — | — | 0 | No | 14.5 | 10.4 | Comp. |
| b9 | 9 | — | — | 0 | No | 14.8 | 10.4 | Comp. |

*¹Compound:
1: Polyoxyethylene(5)-tert-tridecylamine ether [H₃C(CH₂)₃]₃C—NH—(C₂H₄O)₅H
2: polyoxyethylene(7)-2-propyl heptyl ether H₃C(CH₂)₄—CH[(CH₂)₂CH₃]CH₂—O—(C₂H₄O)₇H
3: polyoxyethylene(7)-tert-tridecyl ether [H₃C(CH₂)₃]₃C—O—(C₂H₄O)₇H
4: polyoxyethylene(10)-3,5-dimethyl-1-(2-methyl-propyl)hexyl ether H₃CCH(CH₃)CH₂CH(CH₃)CH₂CH[CH₂CH(CH₃)₂]—O—(C₂H₄O)₁₀H
5: polyoxyethylene(7)-1-butyl-octyl ether (C₇H₁₅)CH(C₄H₉)—O—(C₂H₄O)₇H
6: polyoxyethylene(3)-tert-tridecyl ether [H₃C(CH₂)₃]₃C—O—(C₂H₄O)₃H
7: polyoxyethylene(5)-1-methylpenthyl ether H₃C(CH₂)₃CH(CH₃)—O—(C₂H₄O)₅H
8: polyoxyethylene(16)-stearyl ether H₃C(CH₂)₁₆CO—(C₂H₄O)₁₆H
9: polyoxyethylene(21)-behenyl ether H₃C(CH₂)₂₀CO—(C₂H₄O)₂₁H

TABLE 2

| | | | Plate Life | |
|---|---|---|---|---|
| Developer | | Staining | (×10⁴ | |
| No. | developability | (number/m²) | sheets) | Remark |
| a1 | good*¹ | 0 | 30 | Inv. |
| a2 | good*¹ | 0 | 30 | Inv. |
| a3 | good*¹ | 0 | 30 | Inv. |
| a4 | good*¹ | 0 | 30 | Inv. |
| a5 | good*¹ | 0 | 25 | Inv. |
| a6 | good*¹ | 0 | 25 | Inv. |
| a7 | good*¹ | 0 | 25 | Inv. |
| a8 | poor*² | 4 | 10 | Comp. |
| a9 | poor*² | 9 | 10 | Comp. |
| b1 | good*¹ | 0 | 30 | Inv. |
| b2 | good*¹ | 0 | 30 | Inv. |
| b3 | good*¹ | 0 | 30 | Inv. |
| b4 | good*¹ | 0 | 30 | Inv. |
| b5 | good*¹ | 0 | 25 | Inv. |
| b6 | good*¹ | 0 | 25 | Inv. |
| b7 | good*¹ | 0 | 25 | Inv. |
| b8 | poor*² | 7 | 10 | Comp. |
| b9 | poor*² | 18 | 10 | Comp. |

*¹no residual layer was observed
*²residual layer was observed.

As apparent from the Table, it was proved that developers of the invention exhibited superior developability and no minute staining and planographic printing plates obtained by processing method of light-sensitive printing plate material according to the invention were also superior in printing properties.

What is claimed is:

1. A developer used for developing a planographic printing plate material, wherein the developer is an alkaline solution comprising a compound represented by formula (1):
Rₗ—O—(R₂—O)ₙ—H formula (1)
wherein R₁ is a branched alkyl group having carbon atoms of not more than 20 which may be interrupted by —NH—; R₂ is an alkylene group having carbon atoms of 1 to 10; and n is an integer of 2 to 100.

2. The developer of claim 1, wherein in the formula (1), R₁ is a branched alkyl group comprising a main chain and one or more side chains and a ratio of C₂/C₁ is from 0.05 to 3.0, wherein C₁ is the number of carbon atoms of the main chain and C₂ is the total number of carbon atoms of the side chains.

3. The developer of claim 1, wherein in the formula (1), R₁ is a branched alkyl group comprising a main chain having carbon atoms of 3 to 19 and at least one side chain having carbon atoms of 1 to 9.

4. The developer of claim 1, wherein in the formula (1), R₁ is a branched alkyl group which is interrupted by —NH—.

5. The developer of claim 1, wherein the compound represented by formula (1) exhibits an HLB value of 11 to 15.

6. The developer of claim 1, wherein the developer is an alkaline solution exhibiting a pH of 8.5 to 13.0.

7. The developer of claim 1, wherein the printing plate material comprises on a support a light-sensitive layer comprising an ethylenically unsaturated monomer, a photopolymerization initiator and a polymeric binder.

8. A method of processing a light-sensitive planographic printing plate material comprising the steps of:
(a) imagewise exposing the printing plate material, and (b) processing the exposed printing plate material with a developer,
wherein the developer is an alkaline solution comprising a compound represented by formula (1):
R₁—O—(R₂—O)ₙ—H formula (1)
wherein R₁ is a branched alkyl group having carbon atoms of not more than 20 which may be interrupted by —NH—; R₂ is an alkylene group having carbon atoms of 1 to 10; and n is an integer of 2 to 100.

9. The method of claim 8, wherein in the formula (1), R₁ is a branched alkyl group comprising a main chain and one or more side chains and a ratio of C₂/C₁ is from 0.05 to 3.0, wherein C₁ is the number of carbon atoms of the main chain and C₂ is the total number of carbon atoms of the side chains.

10. The method of claim 8, wherein in the formula (1), R₁ is a branched alkyl group comprising a main chain having carbon atoms of 3 to 19 and at least one side chain having carbon atoms of 1 to 9.

11. The method of claim 8, wherein in the formula (1), R₁ is a branched alkyl group which is interrupted by —NH—.

12. The method of claim 8, wherein the compound represented by formula (1) exhibits an HLB value of 11 to 15.

13. The developer of claim 8, wherein the developer is an alkaline solution exhibiting a pH of 8.5 to 13.0.

14. The developer of claim 8, wherein the printing plate material comprises on a support a light-sensitive layer comprising an ethylenically unsaturated monomer, a photopolymerization initiator and a polymeric binder.

15. The method of claim 6, wherein the method further comprises:
(c) washing the processed printing plate material with a washing water.
